(19) United States
(12) Patent Application Publication
(10) Pub. No.: US 2019/0203522 A1
(43) Pub. Date: Jul. 4, 2019

(54) FRAME FOR MANUFACTURING LARGE-SURFACE DOORS OR WINDOWS

(71) Applicant: BBG S.A., Esposende (PT)

(72) Inventor: Hugo Miguel MACHADO RAINHA, Maia (PT)

(21) Appl. No.: 16/300,572

(22) PCT Filed: Apr. 28, 2017
(86) PCT No.: PCT/IB2017/052488

§ 371 Date: Nov. 11, 2018

(30) Foreign Application Priority Data
May 10, 2016 (PT) 109377

(51) Int. Cl. E06B 3/46; E06B 3/12; E06B 3/66; E05B 65/08

(52) U.S. Cl. CPC E06B 3/4609; E06B 3/12; E05Y 2900/148; E05B 65/08; E05Y 2900/132; E06B 3/66

(57) ABSTRACT

The present invention consists of aluminum frames for manufacturing doors or windows, with or without thermal break, which is applied in a door or window opening of a building. It is constituted by at least one fixed frame (1) which may or may not be integrated in the floor, in the ceiling, or in the walls, and fixed or movable sashes (3) which have central posts (5) and handle (4). The locking system (6) of the sashes (3) is integrated in the aluminum profiles of the fixed frame (1) and makes it possible to adjust the number of locking points to the size of the sashes (3). The sashes (3) have no visible aluminum profiles next to the floor and next to the ceiling. In the zone of the posts (5) and of the handles the visible aluminum thickness ranges from 1 mm to 5 mm.

### TECHNICAL FIELD OF THE INVENTION

The present invention relates to frames for manufacturing large area doors or windows, having no visible aluminum profiles near the floor and near the ceiling, which is within the field of mechanical engineering applied to civil engineering, more specifically regarding fixed construction elements. Additionally, the invention falls within the scope of the International Patent Classification E06B7/14; E06B03/46; E06B5/20 and E06B7/23.

The present invention has the following advantages over the aforementioned prior art:

a) No visible aluminum profiles near the floor and near the ceiling;

b) At the heights near the posts (5) only 1 mm to 5 mm of aluminum is visible;

c) The profiles of the posts (5) have thermal break;

d) At the heights near the handles (4) only 1 mm to 5 mm of aluminum is visible;

e) The upper and lower profiles (2) of the sash (3) are not visible and they are a structural part of the sash, and low friction material bars are attached in the lower profile (2). These bars are in contact with the bearings thus allowing a smooth sliding of the sashes;

f) The thickness of the glass panes can vary from 34 mm to 60 mm, only by changing the peripheral profile (7) which is coupled to the sashes (3), and keeping unchanged the profiles of the fixed frame (1);

g) Possibility of movement of the sashes (3) in parallel or perpendicular planes;

h) Any type of fixation elements—such as screws, female fittings, rivets or other—are not visible;

i) Using the same profiles, it is possible in with this system to produce frames with positive or negative slope, attic ceiling frames, skylights, guillotines, and pivoting doors.

It must be mentioned that the closest document to the state-of-the art of the invention is the patent application EP2853674, which differs from the present invention in that the post and the handle are only 1 mm to 5 mm visible and in this way it is possible to hide the fixed frame (1) in the floor, in the ceiling and in the walls.

### DESCRIPTION OF THE INVENTION

The present invention is an aluminum and glass frame system for manufacturing doors or windows, which is applied in an opening of a building.

The present invention is constituted by at least one fixed frame (1) and by just one or several fixed or movable sashes (3), which are inserted inside the fixed frame (1) and move laterally in parallel or perpendicular planes. The sashes (3) can be moved by hand or in a motorized way, and may consist of single, double, or triple panes of glass or other type of material. The sashes (3) have a central post (5), as shown in FIG. 2, which have profiles (2) with 1 mm to 5 mm. At the other end it is possible they include a handle (4) equally with 1 mm to 5 mm of visible aluminum. In this way there are no visible aluminum profiles in the floor or in the ceiling.

The fixed frame (1) is peripheral and consists of a rigid aluminum frame, preferably rectangular or square. All sides of the fixed frame (1) are formed by the same profile, and are joined together by any means known in the art.

In any of these cases it is always used the same fixed frame profile (1).

The sash (3) has a peripheral profile (7) which is attached to glass by a gluing process or any other known in the art, in which this profile has a structural function and allows fitting the profiles of the handle (4) and of the post (5) by means of cleavage or by gluing. This profile can be made of aluminum or polyamide.

The sash (3) can have glass thicknesses ranging from 34 mm to 60 mm, for which it is only necessary to replace the peripheral profile (7) with an equivalent one.

The sashes (3) can be operated by hand or automatically. The profiles forming the fixed frame (1) have been developed in order to allow the automation of the sashes (3) movement without needing to add more profiles to the system.

The locking system (6) of the movable sashes is integrated in the aluminum profiles of the fixed frame (1) and allows adjusting the number of locking points to the size of the movable sashes. The locking system (6) is multipoint, the number of locking points being adjusted according to the height and weight of the sashes (3).

### BRIEF DESCRIPTION OF THE FIGURES

### List of Reference Numbers

fixed frame (1);
lower/upper profile (2);
movable/fixed sashes (3);
handle (4);
central post (5);
locking system (6) of the movable sashes.

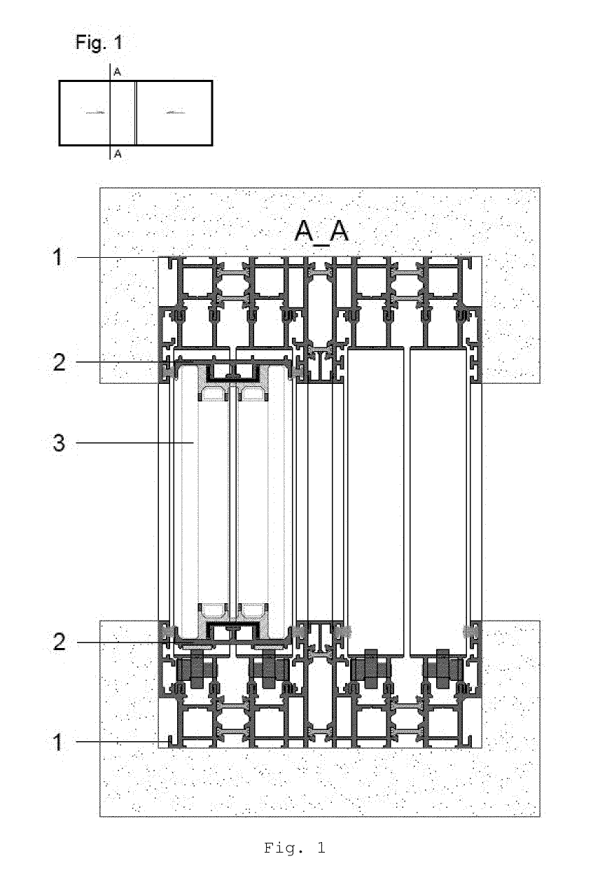

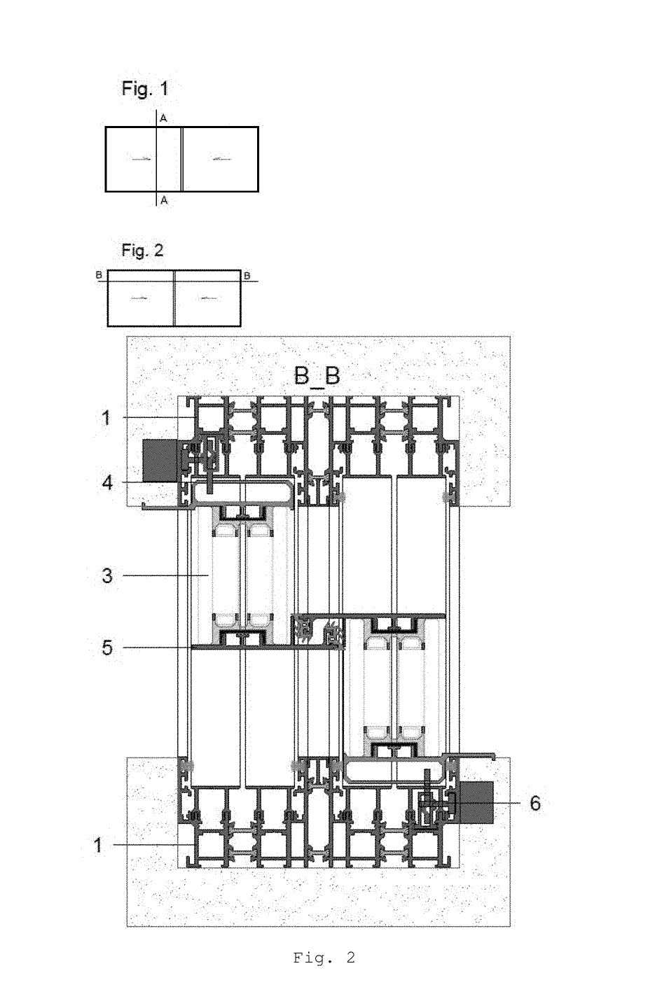

FIG. 1—Graphical representation of the frames—vertical section.

FIG. 2—Graphic representation of the frames horizontal section.

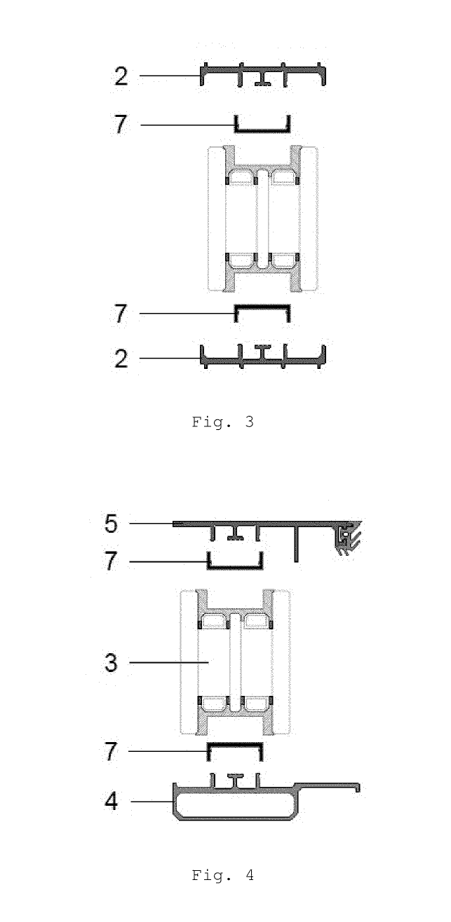

FIG. 3—Graphical representation of the sashes (3) that compose the vertical section system.

FIG. 4—Graphical representation of the sashes (3) that compose the horizontal section system.

1. Frames for manufacturing doors or windows consisting of:
a) at least one peripheral fixed frame (1) consisting of a rigid aluminum frame in which all sides are made with the same profile;
b) at least one fixed or movable sash (3) inserted inside the fixed frame (1) and which moves laterally in parallel or perpendicular planes;
c) locking system (6) of the sashes (3) integrated in the aluminum profiles of the fixed frame (1), which is multipoint;
characterized in that the sash (3) has:
d) a central post (5) with upper and lower profiles (2) with 1 mm to 5 mm and a peripheral profile (7) coupled to the sashes (3) and attached to glass;
e) at one end a handle (4) with 1 mm to 5 mm of visible aluminum.

2. Frames according to claim 1, characterized in that the sash (3) consists of single, double, or triple panes of glass or other type of material.

3. Frames according to claim 1, characterized in that the sash (3) has glass thicknesses between 34 mm and 60 mm.

4. Frames according to claim 1, characterized in that the peripheral profile (7) is made of aluminum or polyamide.
